(19) United States
(12) Patent Application Publication
(10) Pub. No.: US 2026/0332007 A1
(43) Pub. Date: Oct. 22, 2026

(54) ELECTRIC MACHINE WITH CONTROLLER USING MODIFIED ENERGIZATION SEQUENCE TO AVOID RESONANCE

(71) Applicant: SKF CANADA LIMITED, Scarborough (CA)

(72) Inventors: Gregory W. SMITH, Calgary (CA); Jeffrey Russell SMITHANIK, Calgary (CA); Marcelo Paolo LI GONZALES, Calgary (CA); Mohammed MUSTAFA, Calgary (CA)

(21) Appl. No.: 19/180,267

(22) Filed: Apr. 16, 2025

(51) Int. Cl. H02K 11/33; H02K 1/12; H02K 1/22

(52) U.S. Cl. CPC H02K 11/33; H02K 1/12; H02K 1/22

(57) ABSTRACT

An electric machine includes a rotor, a stator disposed about the rotor and including a plurality of poles with electromagnetic coils, an electric power source electrically connected with the stator coils, a commutating circuit electrically connecting the power source with the coils and a controller. The controller operates the commutating circuit in an energization sequence such that current flows alternatively through the first and second phases of the electromagnetic coils, the controller repeating the energization sequence at an energization frequency proportional to the rotation frequency. However, the controller modifies the energization sequence such that current flow is prevented or reduced through at least one of the first and second phases of the electromagnetic coils when the controller determines that rotation speed of the rotor is approaching a value at which energization frequency creates resonance within the rotor.

### BACKGROUND OF THE INVENTION

The present invention relates to electric machines, and more particularly to electric machines including rotors driven by variable or switched reluctance.

Electric machines such as motors, rotating levitation platforms, etc., which are driven by switched reluctance are known. Such devices typically include a rotor formed of a ferromagnetic material and having a plurality of teeth or projections and a stator disposed about the rotor and including a plurality of poles each having an electromagnetic coil. The stator poles or coils are arranged in two or more groups or “phases” that are separately connected to an electric power source.

As such, electric power is separately provided to each phase when the poles of the particular phase are angularly spaced or radially unaligned with the teeth of the rotor, such that magnetic flux generated by current through each associated coil passes through two of the unaligned rotor projections and exerts a pulling force that creates torque on the rotor. As the rotor projections angularly displace toward alignment with the poles of a particular phase, the power is switched to another phase such that torque is continuously applied to the rotor. To implement the required switching between the stator phases, such electric machines typically include a commutating circuit separately controlling current to each phase and a controller to operate the commutating circuit to properly time the switching between the stator phases.

As the rotation speed of the rotor increases, the timing of the phase switching or the “energization frequency” correspondingly increases. Generally, the energization frequency is proportional to the rotation frequency, specifically multiplied by the number of projections of the rotor. Although such electric machines perform generally satisfactorily, undesired vibration in the rotor may occur when the rotor transitions through certain speeds at which the energization frequency exerts an amount of torque at a rate that stimulates resonance within the rotor.

### SUMMARY OF THE INVENTION

In one aspect, the present invention is an electric machine for angularly displacing at least one object, preferably one or more semiconductor wafers, about a central axis. The machine comprises a rotor formed of a ferromagnetic material and including a circular body and a plurality of projections extending radially outwardly from the body and spaced circumferentially about the central axis, the rotor being configured to support the at least one object. A stator is disposed about the rotor and includes a plurality of poles spaced radially outwardly from the rotor projections and circumferentially about the central axis, each pole including an electromagnetic coil and being configured to generate magnetic flux through two or more of the rotor projections and another one of the stator poles such that torque is applied to the rotor to angularly displace the rotor at a variable rotation frequency. An electrical power source is electrically connected with a commutating circuit that electrically connects the power source with the electromagnetic coils of the plurality of stator poles. The commutating circuit includes a first amplifier controlling current flow through a first phase of the stator electromagnetic coils and a second amplifier controlling current flow through a second phase of the stator electromagnetic coils. A controller is configured to operate the commutating circuit in an energization sequence such that current flows alternatively through the first and second phases of the electromagnetic coils, the controller repeating the energization sequence at an energization frequency proportional to the rotation frequency. The controller is further configured to modify the energization sequence such that the current flow is prevented or reduced through at least one of the first and second phases of the electromagnetic coils when the controller determines that rotation speed of the rotor is approaching a value at which energization frequency creates resonance within the rotor.

Preferably, the controller is configured to operate the commutating circuit during the modified energization sequence such that at least one of: an amplitude of current in at least one of the first and second phases of the electromagnetic coils is reduced; current flow is entirely prevented through one of the first and second phases of the electromagnetic coils; and current flow is permitted through only one of the first and second phases of the electromagnetic coils during every other one of the modified energization sequences and permitted through only the other one of the first and second electromagnetic coils during each other modified energization sequence.

Further, the controller is preferably configured to initiate the modified energization sequence whenever the rotation speed of the rotor approaches a predetermined value stored within a memory of the controller. Also, the controller is configured to operate the commutating circuit in the standard energization sequence whenever the rotation speed of the rotor is outside of a band about the value.

Preferably, the electric machine further comprises at least one position sensor configured to sense an angular position of the rotor about the central axis and electrically connected with the controller. Also, the plurality of poles of the stator are preferably provided by a plurality of motor actuators, each motor actuator including a base member with two ferromagnetic pole sections and two of the plurality of electromagnetic coils each disposed about a separate one of the base pole sections. Each one of the first and second phases of the plurality of coils includes at least two of the motor actuators. Furthermore, each motor actuator interacts with two of the plurality of rotor projections such that a magnetic flux path extends outwardly from one of the pole sections into one of the two rotor projections, through a portion of the rotor annular body between the two rotor projections, radially outwardly from the other one of the two rotor projections and into the other one of the two pole sections, the magnetic flux exerting a pulling force on both of the two rotor projections to generate torque about the central axis.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is top plan view of an electric machine in accordance with the present invention, showing a rotor at one angular position about a central axis and with a first phase of stator poles being energized;

FIG. 2 is another top plan view of the electric machine of the present invention, showing the rotor at another angular position and with a second phase of the poles being energized;

FIG. 3 is an axial cross-sectional view of the electric machine;

FIG. 4 is a schematic diagram of the electric machine, showing a commutating circuit with switching amplifiers separating the stator poles into three phases;

FIG. 5 is a graph of a flow of current I through separate phases of stator coils over time t in a standard energization sequence; and

FIGS. 6A-6G, collectively FIG. 6, are each a separate graph of the current I through separate phases of stator coils over time t during a modified energization sequence.

### DETAILED DESCRIPTION OF THE INVENTION

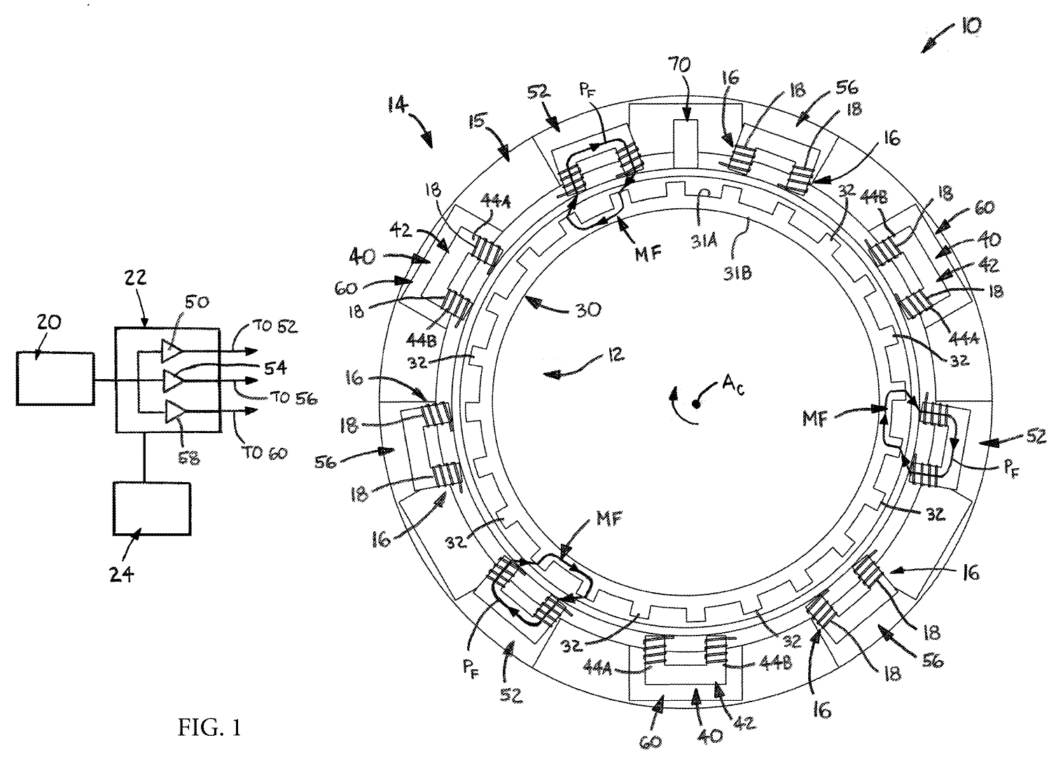

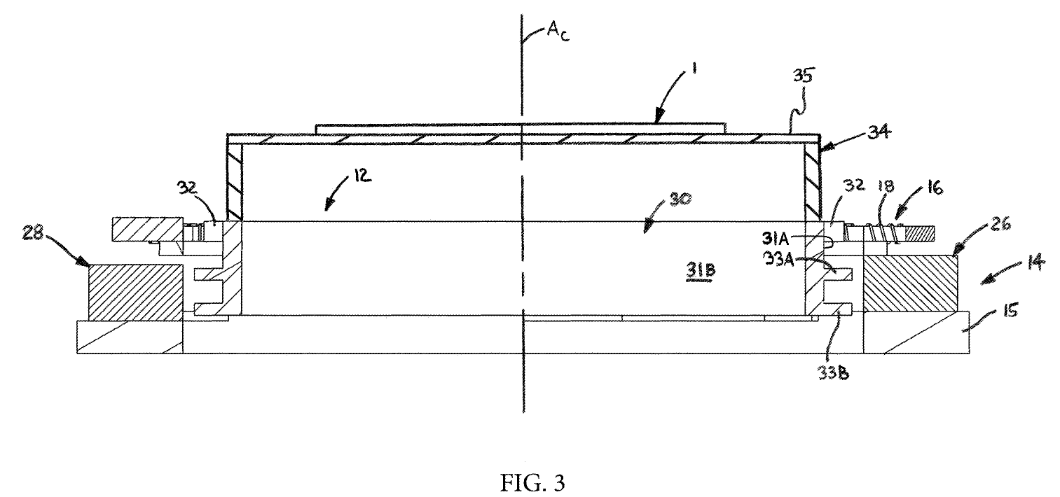

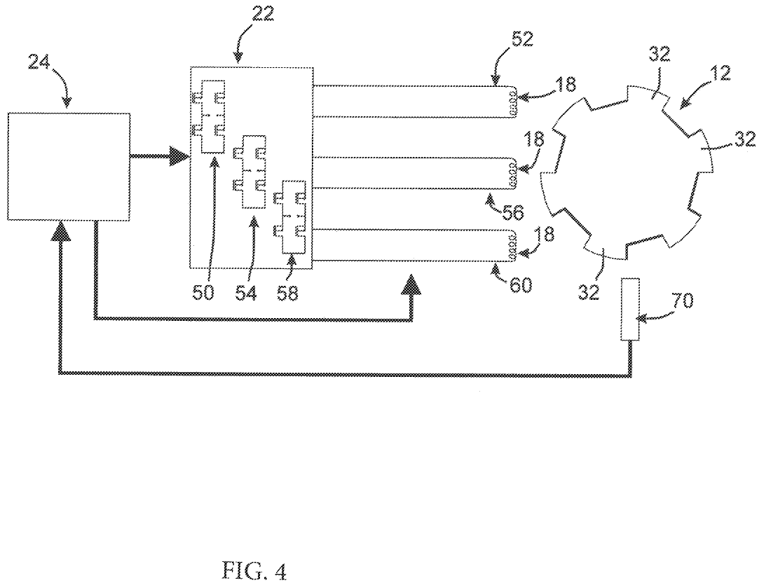

Referring now to the drawings in detail, wherein like numbers are used to indicate like elements throughout, there is shown in FIGS. 1-6 an electric machine 10 for angularly displacing at least one object 1 (FIG. 3) about a central axis A_{C}. The machine 10 is preferably a magnetically levitated platform assembly for processing semiconductor wafers (i.e., the object(s) 1 are wafers) as depicted, but may be any other appropriate device or machine incorporating a switched reluctance motor. The electric machine 10 basically comprises a rotor 12, a stator 14 disposed about the rotor 12 and including a plurality of poles 16 with electromagnetic coils 18, an electric power source 20 electrically connected with the stator coils 18, a commutating circuit 22 electrically connecting the power source 20 with the coils 18 and a controller 24.

The controller 24 is configured to operate the commutating circuit 22 in both a standard energization sequence of the stator coils 18, to generally accelerate, maintain rotation speed and decelerate the rotor 12 about the central axis A_{C}, and in a modified energization sequence when the rotor 12 approaches a rotation speed or frequency at which a standard energization sequence of the coils 18 may cause resonance, as discussed below. In the preferred application of a levitation platform assembly, the electric machine 10 further comprises at least one and preferably a plurality of levitation actuators 26 (only one shown) each configured to exert a magnetic lifting force on the rotor 12 so as to maintain the rotor 12 at a desired vertical position along the central axis A_{C}.

More specifically, the rotor 12 is formed of a ferromagnetic material, such as iron, mild steel, etc., and includes a circular body 30 and a plurality or “n” number of projections 32, n being twenty-four in a presently preferred construction. The rotor body 30 is preferably annular and includes outer and inner circumferential surfaces 31A, 31B, respectively, and opposing upper and lower axial ends (not indicated). The plurality of projections 32 extend radially outwardly from the outer circumferential surface 31A of the body 30 and are spaced circumferentially about the central axis A_{C}. Although the projections 32 are separated by air gaps (not indicated) in a presently preferred embodiment, the gaps/spaces between each pair of adjacent projections 32 may be filled with a non-ferromagnetic material such that the rotor 30 has a smooth, continuous surface (not indicated) at the outer ends of the projections 32. Preferably, the rotor body 30 also includes two axially spaced-apart, annular flanges 33A, 33B spaced vertically below the projections 32, as shown in FIG. 3, on which the levitation actuator(s) 26 exert magnetic flux to levitate the rotor 12. Further, the rotor 12 is configured to support the at least one object 1 and preferably includes a platform 34 supported by the annular body 30 and having an upper surface 35 for receiving the at least one object 1, as shown in FIG. 3.

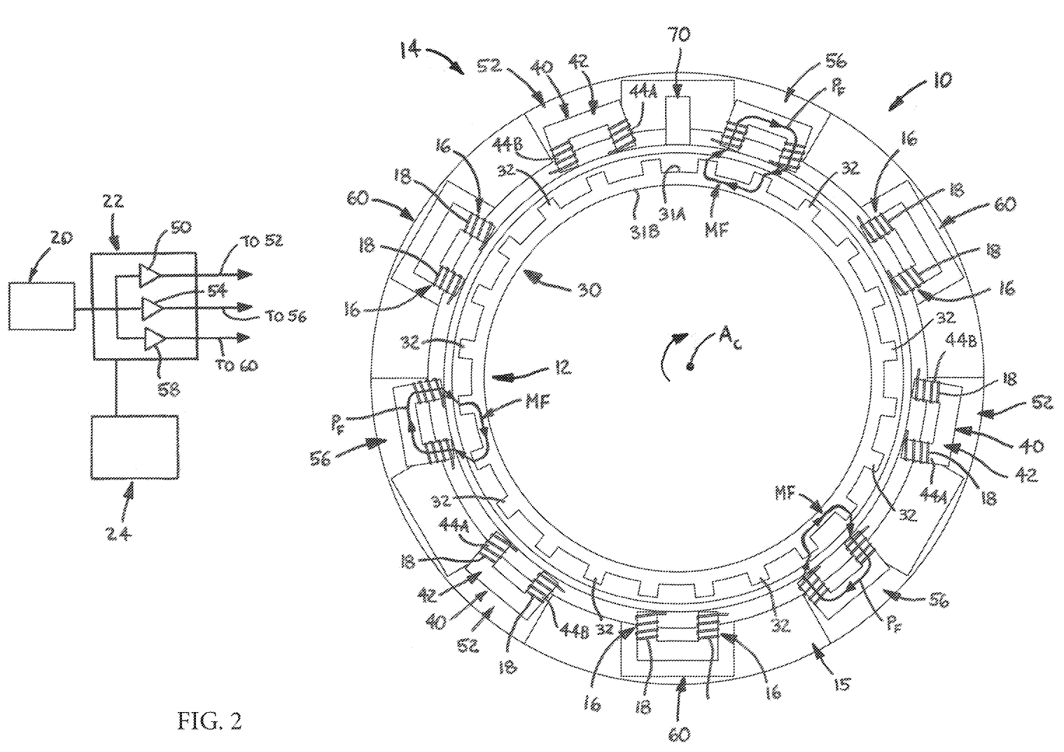

Furthermore, the plurality of poles 16 of the stator 14 are mounted on an annular base 15 and are spaced radially outwardly from the rotor projections 32 and circumferentially about the central axis A_{C}. In the presently preferred construction, the number of poles 16 is eighteen, but may be any other appropriate number depending on the particular application of the machine 1. As depicted in FIGS. 1 and 2, when electric current passes through the electromagnetic coils 18 of the poles 16, each pole 16 is configured to generate magnetic flux MF through two or more of the rotor projections 32 and another one of the poles 16. As such, torque is continuously applied to the rotor 12 to angularly displace the rotor 12 at a variable rotation frequency as discussed in further detail below.

Preferably, the plurality of stator poles 16 are provided by a plurality of motor actuators 40 which each include two of the poles 16. Specifically, each motor actuator 40 includes a base member 42 with two ferromagnetic pole sections 44A, 44B and two of the plurality of coils 18 each disposed about a separate one of the base pole sections 44A, 44B. However, the stator poles 16 may alternatively be provided by individually formed and wired poles (not depicted).

With the preferred motor actuators 40, each actuator 40 interacts with two of the rotor projections 32 such that a magnetic flux path P_{F} extends outwardly from one of the pole sections 44A into one of the two rotor projections 32, through a portion of the rotor body 30 between the two rotor projections 32, radially outwardly from the other one of the two rotor projections 32 and into the other one of the pole sections 44B. Thereby, the magnetic flux MF exerts a pulling force on both of the two rotor projections 32, and when the energization of the coils 18 is properly timed, as discussed below, such that the flux MF is generated when the projections 32 are not radially aligned with the poles 16 (i.e., are angularly spaced apart), the magnetic flux MF generates torque about the central axis A_{C}.

Referring to FIGS. 1 and 2, the electrical power source 20 is preferably a source of alternating current, such as a connection to a power grid, an inverter, a generator, etc., but may alternatively be a source of direct current, such as battery, an inverter, etc. In any case, the commutating circuit 22 is configured to adjustably electrically connect the power source 20 with the stator poles 16 such that both the amplitude of the electric current to the poles 16 is regulated (i.e., increased, decreased or maintained constant) and also the current flow may be alternatively permitted and interrupted.

Preferably, the commutating circuit 22 includes at least a first amplifier 50 controlling current flow through a first “phase” 52 of the electromagnetic coils 18 and a second amplifier 54 controlling current flow through a second phase 56 of the electromagnetic coils 18, and preferably also includes a third amplifier 58 controlling current flow through a third phase 60 of the coils 18. More specifically, each phase 52, 56, 60 is a group or set of the magnetic coils 18 which are spaced circumferentially apart and are each electrically connected with a separate amplifier 50, 54 and 58, respectively. Also, all of the coils 18 of each particular phase 52, 56, 60 are operated simultaneously, and the coils 18 of the different phases 52, 56, 60 are operated sequentially, in order to ensure that torque is constantly applied to the rotor 12, which only occurs when magnetic flux MF is generated through rotor projections 32 that are radially unaligned with the stator poles 16 that generate the flux MF, as is well known in the art of switched reluctance motors.

Therefore, the controller 24 operates the commutating circuit 22 such that each phase 52, 54, 56 is energized (i.e., receives electric current I) when the rotor projections 32 are unaligned with the poles 16 of the particular phase 52, 54, 56 and then de-energized as the rotor projections 32 approach alignment with the stator poles 16. FIG. 1 depicts energization of the first phase 52 and FIG. 2 depicts energization of the second phase 56. Such energization of the phases 52, 56, 60 occurs in a repeated energization sequence as discussed in further detail below. Further, each amplifier 50, 54, 58 is preferably configured to adjust the amplitude of current I through each phase 52, 56, 60 and is configured to alternatively enable and inhibit current I through each phase 52, 56, 60, and may be formed, for example, as an H-bridge amplifier. However, it must be noted that when the phases 52, 56, 60 are operated sequentially, there is some “overlap” of current flow through the phases 52, 56, 60 when current I is initially inhibited in one phase 52, 56, 60 while current I is initially enabled in the next phase 52, 56, 60.

In the preferred construction, each phase 52, 56, 60 includes at least two and preferably three motor actuators 40 which are each electrically connected with the power source 20 through a separate one of the amplifiers 50, 54, 58, respectively, together as a set or phase, as depicted in FIGS. 1 and 2. The three actuators 40 of each phase 52, 56, 60 are spaced apart about the central axis A_{C} by about one hundred twenty degrees so that torque is applied to the rotor 12 in balanced manner. Alternatively, when there are a different number of motor actuators 40 in each phase 52, 56, 60 or a different number of phases (i.e., two phases or four or more phases), the actual number of motor actuators 40 are evenly angularly spaced apart to ensure balancing of the applied torque.

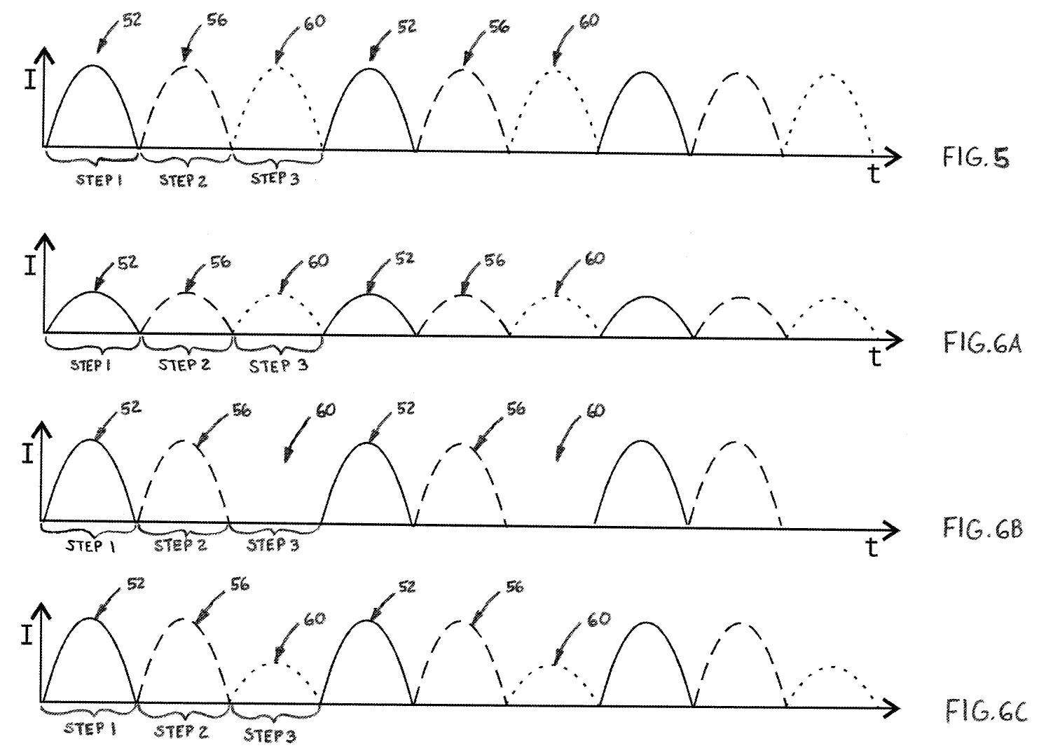

With the above-described arrangement of the stator poles 16, preferably provided by the motor actuators 40, and the commutating circuit 22, the controller 24 is configured to operate the commutating circuit 22 in both a standard energization sequence and a modified energization sequence, as stated above. In the standard energization sequence depicted in FIG. 5, the controller 24 operates the commutating circuit 22 such that current I flows alternatively and sequentially through the first, second and third phases 52, 56, 60 of the electromagnetic coils 18, which is accomplished by alternatively opening and closing the respective amplifiers 50, 54, 58 regulating current through each phase 52, 56, 60. That is, in a first step in the energization sequence, current I flows only through the electromagnetic coils 18 of the first phase 52, in a second step of the sequence, current I flows only through the coils 18 of the second phase 56 and in a third step of the sequence, current I only flows through the coils 18 of the third phase 60.

The controller 24 repeats the energization sequence at an energization rate or frequency which is proportional to the rotation frequency; in other words, as the rotor 12 accelerates or decelerates due to the applied torque, the energization frequency correspondingly increases or decreases to ensure that magnetic flux MF is generated within the rotor projections 32 only when the projections 32 are angularly offset from the poles 16. In the preferred construction of the rotor 12 having twenty-four projections 32, the energization frequency is twenty-four times the rotor speed or rotation frequency.

In order to properly coordinate the “switching” of the phases 52, 56, 60 with the angular position of the rotor 12, the electric machine further comprises at least one position sensor BRIEF DESCRIPTION OF THE SEVERAL VIEWS OF THE DRAWINGS. The one or more position sensors 70 are each configured to sense an angular position of the rotor 12 about the central axis A_{C} and is electrically connected with the controller 24. Using position information from the sensor(s) 70, the controller 24 is able to determine both the angular position of the rotor 12 and the rotation speed or frequency of the rotor 12.

In general, the controller 24 continuously adjusts the energization frequency as the rotation frequency increases or decreases so as to remain proportional and continually apply torque to the rotor 12. However, when the rotation speed of the rotor 12 approaches certain values at which the torque applied by the normal excitation sequence results in resonant excitation of the rotor 12, vibration of the rotor 12 may occur. Such vibration is particularly problematic for the preferred application of the electric machine 10 in semiconductor wafer processing. Specifically, any vibration of the rotor 12 may cause the object 1, i.e., the one or more semiconductor wafers, to become displaced from a desired position on the platform surface 35 as these wafers are typically not retained in place by any mechanical device or other means as such devices may interfere with processing of the wafer.

Such resonant rotation speeds or resonant frequencies are preferably determined in a “commissioning process” by which the electric machine 10 is operated to rotate the rotor 12 from zero velocity to a desired final or operating speed and detecting at which particular rotational speeds the energization frequency causes vibration or oscillation of the rotor 12 beyond an acceptable value or amount, which indicates a resonant frequency of the rotor 12. Such values are then stored within a memory (not indicated) of the controller 24. Alternatively, the electric machine 10 may be provided with a vibration sensor (not depicted) or other sensing means to detect when the rotor 12 is approaching a rotation speed at which the energization frequency creates resonance, which may be connected with the controller 24 to enable the controller 24 to detect the resonance rather than using stored values determined in a commissioning process. Further, as integer multiples or harmonics of the resonant frequency also cause excessive vibration or oscillations of the rotor 12, these values are also stored within the controller’s memory or detected by appropriate means.

Regardless of the specific means for detecting or determining a rotor resonance, the controller 24 is further configured to modify the energization sequence, such that the current flow is prevented and/or reduced through at least one of the first, second and third phases 52, 56, 60 of the electromagnetic coils 18, when the controller 24 determines that rotation speed of the rotor 12 is approaching a value at which energization frequency creates resonance within the rotor 12. Preferably, the controller 24 is configured to initiate the modified energization sequence whenever the rotation speed of the rotor 12 approaches a predetermined value stored within a memory of the controller 24, and most preferably whenever the rotation speed of the rotor 12 is within a band about the stored value, such as for example, plus or minus one hertz (+/- 1 Hz) about each predetermined rotation speed value. Alternatively, when the electric machine 10 includes a means for detecting resonance, the controller 24 may be configured to operate the commutating circuit 22 in the modified energization sequence whenever such resonance is detected.

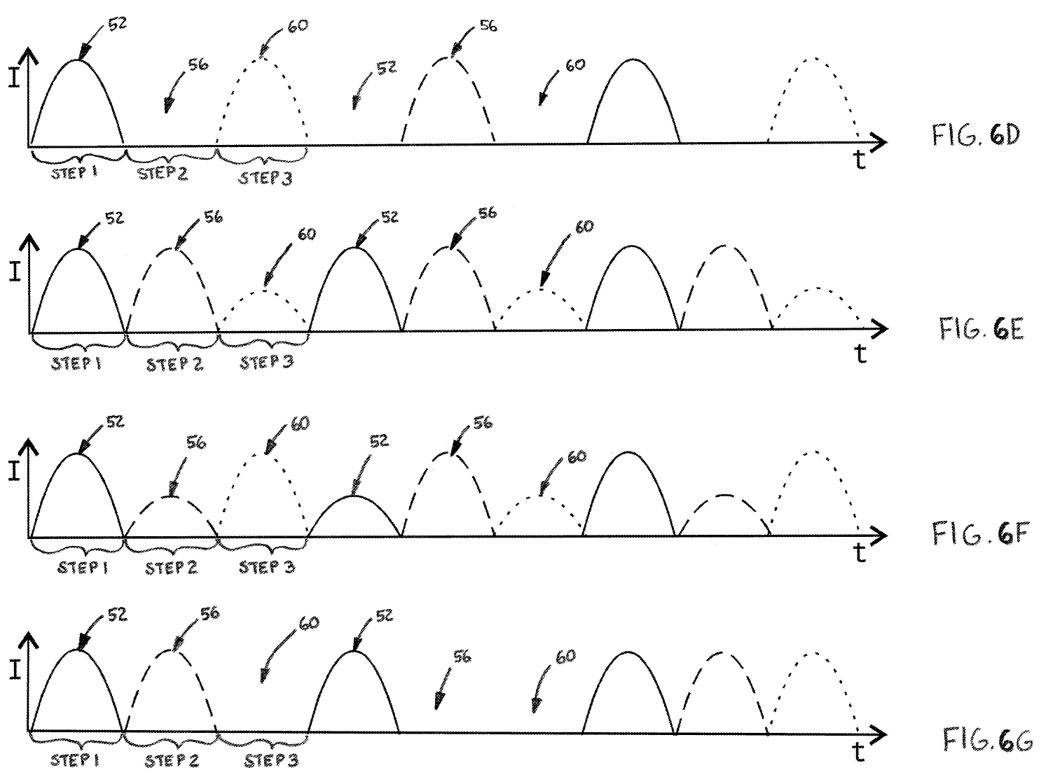

In any case, the controller 24 is configured to operate the commutating circuit 22 during the modified energization sequence such that the amplitude of current I in at least one of the first, second and third phases 52, 56, 60, respectively, is reduced and/or current flow is entirely prevented through one or more of the phases 52, 56, 60. More specifically, the controller 24 may be configured to operate the commutating circuit 22 by adjusting one or more of the amplifiers 50, 54, 58 to reduce the amplitude of current I through one or more of the respective phases 52, 56, 60 of the electromagnetic coils 18, as depicted in FIGS. 6A, 6C, 6E and 6F. Specifically, the amplitude of current I through all of the phases 52, 56, 60 of the electromagnetic coils 18 may be reduced by a specific amount or percentage, as shown in FIG. 6A, or the amplitude of current I through only one or two of the phases 52, 56 and 60 may be reduced with respect to the amplitude in the other phase(s), as shown in FIGS. 6C, 6E and 6F.

Alternatively, the controller 24 may retain one (or more) of the amplifiers 50, 54, 58 in an open state during the entire modified energization sequence, thereby preventing current flow to the electromagnetic coils 18 of the associated phase 52, 56, 60, in the particular step in the energization sequence during which current I would normally flow to the particular set of coils 18. That is, in the normal energization sequence, current I flows to only the coils 18 of the first phase 52 in the first step, then only to the coils 18 of the second phase 56 in the second step, then only to the coils 18 of the third phase 60 in the third step, and this sequence is continuously repeated, as depicted in FIG. 6.

However, in the modified energization sequence, one or more of the amplifiers 50, 54, 58 may be operated by the controller 24 such that no current I flows to the connected electromagnetic coils 18 during the step in the sequence for the particular phase or phases 52, 56, 60. For example, as shown in FIG. 6B, the modified energization sequence may include energizing only the first and second phases 52, 56, such that no torque is applied to the rotor 12 during the third step in the energization sequence, and this “pattern” may be repeated for the entire duration of the modified energization sequence. Further, instead of omitting the energization of a particular one or more of the phases 52, 56, 60, the controller 24 may randomly omit energizing the electromagnetic coils 18 of one or two of the phases 52, 56, 60 during each energization sequence, as depicted in FIG. 6G.

Furthermore, the controller 24 may implement a modified energization sequence in which the amplitude of current I in one or more of the phases 52, 56, 60 is reduced while current flow to another one of the phases 52, 56, 60 is entirely prevented. Thus, the modified energization sequence may include any combination of amplitude reduction and/or “skipping” of the normal energization step of one or more phases 52, 56, 60 during the modified sequence. Also, the energization sequence may be modified in any other manner dependent also upon the actual number of phases of the electromagnetic coils 18 or motor actuators 40. For example, when the electromagnetic coils 18 are operated or arranged in only two phases, current flow may be permitted through only one of the first and second phases of the electromagnetic coils 18 during every other one of the modified energization sequences and permitted through only the other one of the first and second phases during each other modified energization sequence. Thus, the modified energization sequence may be used to operate two phases, three phases as described above, or four or more phases of the electromagnetic coils 18.

Regardless of the specific modified energization sequence implemented by the controller 24, the total amount of torque applied to the rotor 24 during the energization frequency (always proportional to rotation speed/frequency) is reduced temporarily from a value or magnitude which normally causes resonance in the rotor 12 until the speed of the rotor 12 transitions through the resonant frequency or a harmonic of the resonant frequency. Once the rotor speed transitions through the one or more values at which the energization frequency stimulates resonance in the rotor 12, and preferably through a band about each value, the controller 24 is configured to resume operating the commutating circuit 22 in the normal energization sequence.

Although the electric machine 10 of the present invention is preferably a magnetically levitated platform assembly as described above, the machine 10 may alternatively be constructed as a more conventional switched reluctance motor in which the rotor 12 is mounted to a shaft (not shown) driving a wheel, a mechanism or any other appropriate mechanical device (none depicted). In the preferred construction, the electric machine 10 includes, in addition to the axial levitation actuators 26 as described above, radial position actuators 28 (one shown), axial position sensors, radial position sensors and any other devices or components necessary to operate a magnetically levitated and driven rotor assembly (no other components shown).

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. An electric machine for angularly displacing at least one object about a central axis, the machine comprising:
a rotor formed of a ferromagnetic material and including a circular body and a plurality of ferromagnetic projections extending radially outwardly from the body and spaced circumferentially about the central axis, the rotor being configured to support the at least one object;
a stator disposed about the rotor and including a plurality of poles spaced radially outwardly from the rotor projections and circumferentially about the central axis, each pole including an electromagnetic coil and being configured to generate magnetic flux through two or more of the rotor projections and another one of the stator poles such that torque is applied to the rotor to angularly displace the rotor at a variable rotation frequency;
an electrical power source electrically connected with the electromagnetic coils of the plurality of stator poles;
a commutating circuit electrically connecting the power source with the electromagnetic coils of the plurality of stator poles and including a first amplifier controlling current flow through a first phase of the stator electromagnetic coils and a second amplifier controlling current flow through a second phase of the stator electromagnetic coils; and
a controller configured to operate the commutating circuit in an energization sequence such that current flows alternatively through the first and second phases of the electromagnetic coils, the controller repeating the energization sequence at an energization frequency proportional to the rotation frequency;
wherein the controller is further configured to modify the energization sequence such that the current flow is prevented or reduced through at least one of the first and second phases of the electromagnetic coils when the controller determines that rotation speed of the rotor is approaching a value at which energization frequency creates resonance within the rotor.

2. The electric machine as recited in claim 1, wherein the controller is configured to operate the commutating circuit during the modified energization sequence such that at least one of:
an amplitude of current in at least one of the first and second phases of the electromagnetic coils is reduced;
current flow is entirely prevented through one of the first and second phases of the electromagnetic coils; and
current flow is permitted through only one of the first and second phases of the electromagnetic coils during every other one of the modified energization sequences and permitted through only the other one of the first and second electromagnetic coils during each other modified energization sequence.

3. The electric machine as recited in claim 1, wherein the controller is configured to initiate the modified energization sequence whenever the rotation speed of the rotor approaches a predetermined value stored within a memory of the controller.

4. The electric machine as recited in claim 1, wherein the controller is configured to operate the commutating circuit in the energization sequence whenever the rotation speed of the rotor is outside of a band about the value.

5. The electric machine as recited in claim 1, further comprising at least one position sensor configured to sense an angular position of the rotor about the central axis and electrically connected with the controller.

6. The electric machine as recited in claim 1, wherein the plurality of poles of the stator are provided by a plurality of motor actuators, each motor actuator including a base member with two ferromagnetic pole sections and two of the plurality of electromagnetic coils each disposed about a separate one of the base pole sections, each one of the first and second phases of the plurality of coils including at least two of the motor actuators, each motor actuator interacting with two of the plurality of rotor projections such that a magnetic flux path extends outwardly from one of the pole sections into one of the two rotor projections, through a portion of the rotor annular body between the two rotor projections, radially outwardly from the other one of the two rotor projections and into the other one of the two pole sections, the magnetic flux exerting a pulling force on both of the two rotor projections to generate torque about the central axis.

7. The electric machine as recited in claim 1, wherein:
the commutating circuit further includes a third amplifier controlling current flow through a third phase of the plurality of electromagnetic coils;
the controller is configured to operate the commutating circuit in the energization sequence so that current alternatively and sequentially flows through the first, second and third phases of the electromagnetic coils and to operate the commutating circuit in the modified energization sequence such that current flow is prevented or reduced through at least one of the first, second and third phases of the electromagnetic coils when the controller determines that rotation speed is approaching the value at which energization frequency creates resonance within the rotor.

8. The electric machine as recited in claim 1, wherein the controller is configured to operate the commutating circuit in the modified energization sequence when the rotor speed approaches two or more values at which energization frequency creates resonance within the rotor.

9. The electric machine as recited in claim 1, wherein the rotor has a number n of the projections and the energization frequency has a value of n times a value of the rotation frequency of the rotor.

10. The electric machine as recited in claim 1, wherein the rotor further includes a platform supported by the annular body and having an upper surface for receiving the at least one object.

11. The electric machine as recited in claim 1, further comprising at least one levitation actuator configured to exert a magnetic lifting force on the rotor so as to maintain the rotor at a desired vertical position along the central axis.

12. An electric machine for angularly displacing at least one object about a central axis, the machine comprising:
a rotor formed of a ferromagnetic material and including an annular body and a plurality of ferromagnetic projections extending radially outwardly from the annular body and spaced circumferentially about the central axis, the rotor being configured to support a platform having an upper surface for receiving the at least one object;
a stator including a plurality of motor actuators spaced radially outwardly from the rotor projections and circumferentially about the central axis, each motor actuator including a ferromagnetic base member with two pole sections and two electromagnetic coils disposed about a separate one of the two pole sections and being configured to generate magnetic flux through two or more of the rotor projections such that torque is applied to the rotor to angularly displace the rotor at a variable rotation frequency;
an electrical power source electrically connected with the electromagnetic coils of the plurality of stator poles;
a commutating circuit electrically connecting the power source with the electromagnetic coils of the plurality of stator poles and including a first amplifier controlling current flow through a first phase of the motor actuators, a second amplifier controlling current flow through a second phase of the motor actuators and a third amplifier controlling current flow through a third phase of the motor actuators;
a controller configured to operate the commutating circuit in an energization sequence such that current flows alternatively through the first, second and third phases of the motor actuators, the controller repeating the energization sequence at an energization frequency proportional to the rotation frequency;
wherein the controller is further configured to modify the energization sequence such that the current flow is prevented or reduced through at least one of the first, second and third phases of the motor actuators when the controller determines that rotation speed is approaching a value at which energization frequency generates resonance within the rotor.

13. The electric machine as recited in claim 12, wherein the controller is configured to operate the commutating circuit during the modified energization sequence such that at least one of:
an amplitude of current in at least one of the first, second and third phases of the electromagnetic coils is reduced;
current flow is entirely prevented through one or two of the first, second and third phases of the electromagnetic coils; and
current flow is randomly prevented through one or two of the first, second and third phases of the electromagnetic coils during each modified energization sequence.

14. The electric machine as recited in claim 12, wherein the controller is configured to initiate the modified energization sequence whenever the rotation speed of the rotor approaches a predetermined value stored within a memory of the controller.

15. The electric machine as recited in claim 12, wherein the controller is configured to operate the commutating circuit in the energization sequence whenever the rotation speed of the rotor is outside of a band about the value.

16. A method of operating a switched reluctance motor, the motor including a rotor formed of a ferromagnetic material and having a plurality of ferromagnetic projections, a stator including a plurality of poles each including an electromagnetic coil and being configured to generate magnetic flux through two or more of the rotor projections and another one of the poles, and a commutating circuit electrically connecting an electric power source with the electromagnetic coils so as to define a first phase of the electromagnetic coils and a second phase of the electromagnetic coils, the method comprising the steps of:
providing a controller configured to operate the commutating circuit in an energization sequence such that current flows alternatively through the first and second phases of the electromagnetic coils, the controller repeating the energization sequence at an energization frequency proportional to a rotation frequency of the rotor; and
modifying the energization sequence such that the current flow is prevented and/or reduced through at least one of the first and second phases of the electromagnetic coils when the controller determines that rotation speed of the rotor is approaching a value at which energization frequency creates resonance within the rotor.

17. The method as recited in claim 16, wherein the controller operates the commutating circuit during the modified energization sequence such that at least one of:
an amplitude of current in at least one of the first and second phases of the electromagnetic coils is reduced;
current flow is entirely prevented through one of the first and second phases of the electromagnetic coils; and
current flow is permitted through only one of the first and second phases of the electromagnetic coils during every other one of the modified energization sequences and permitted through only the other one of the first and second electromagnetic coils during each other modified energization sequence.

18. The method as recited in claim 16, wherein the controller initiates the modified energization sequence whenever the rotation speed of the rotor approaches a predetermined value stored within a memory of the controller.
